(19) United States
(12) Patent Application Publication
(10) Pub. No.: US 2017/0312603 A1
(43) Pub. Date: Nov. 2, 2017

(54) GOLF TROLLEY

(71) Applicant: Hsing-Chong Liu, Munich (DE)

(72) Inventor: Hsing-Chong Liu, Munich (DE)

(21) Appl. No.: 15/521,290

(22) PCT Filed: Nov. 2, 2015
(86) PCT No.: PCT/IB2015/002366

§ 371 Date: Apr. 22, 2017

(30) Foreign Application Priority Data
Nov. 5, 2014 (DE) 102014016339.3

(51) Int. Cl. A63B 55/60; B62B 1/04

(52) U.S. Cl. CPC A63B 55/60; B62B 1/047; A63B 2210/50; A63B 2210/58; B62B 2202/406

(57) ABSTRACT

A golf trolley includes a main body that can retracted for storing or transportation and extended for use. The handle of the golf trolley, the wheels and wheel rods are removable. The size of the main body can be thus reduced to a size suitable for putting into a normal luggage for traveling by airplane.

The invention relates the golf trolley, which is easy to be assembled for use and easy to be disassembled for-storing or transportation and it is economical. When it is disassembled, it is so compact that it can be put into a conventional luggage for air travelling.

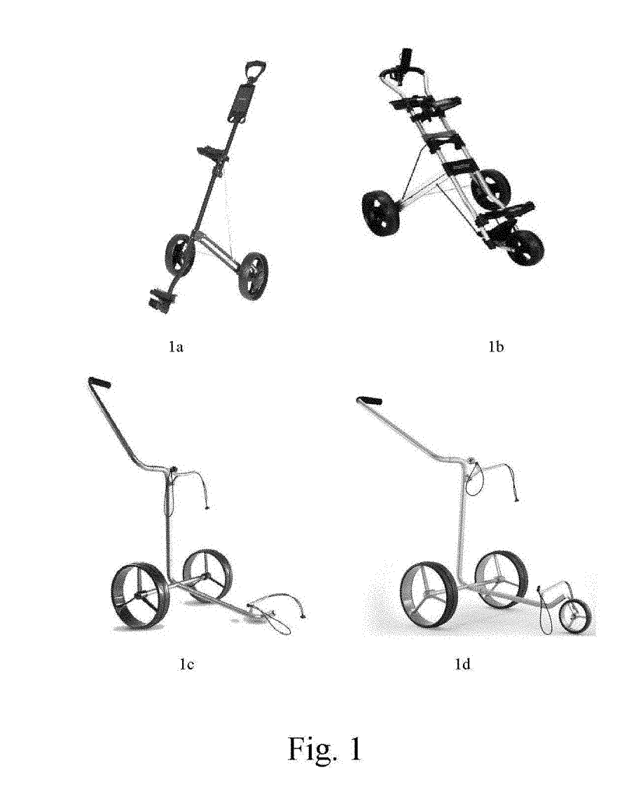

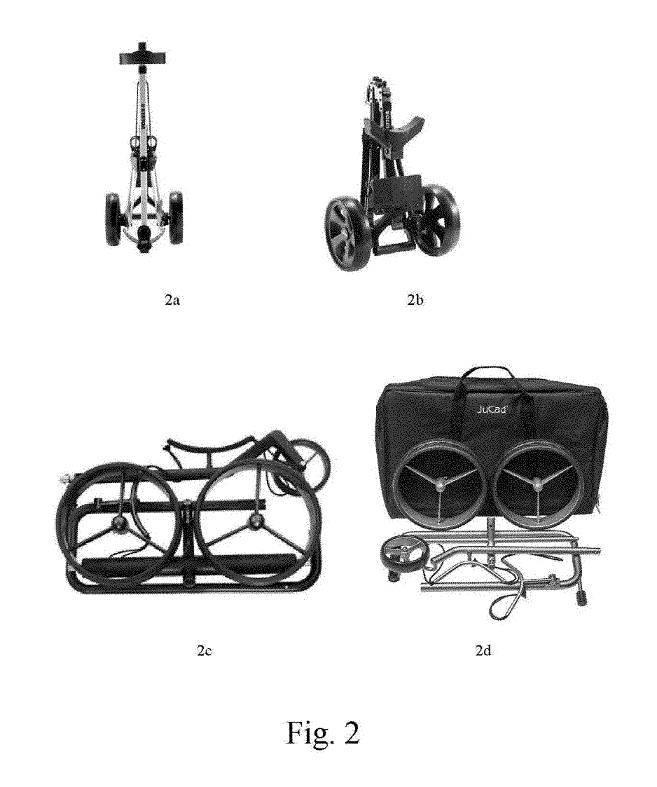

Golf trolley is widely used by golfers. There are various kinds of golf trolleyson the market. Most of them are foldable (FIG. 1a, FIG. 1b, FIG. 2a, FIG. 2b). But it is not so easy to be transported, especially in the air travelling, because it is still too big and bulky. While travelling by airplane, it must be declared as “bulky goods” (FIG. 2a, FIG. 2b) and to pay extra costs.

To solve this problem, there are some improved golf trolleys, which are able to be disassembled and suitable for an ordinary luggage in the air travelling, such as Jucad™ or Ticad™ (FIG. 1c, FIG. 2c, FIG. 1d, FIG. 2d). But they are very much expensive. Therefore, the goal of this invention is to find a golf trolley which is suitable for air travelling, easy to assemble/disassemble and economical.

The technical problem is solved by providing a golf trolley, which main body is made of several tubes. The main body tubes are able to slide into one another to reduce the length of main body for storing or transportation. When the trolley is in storing, all parts will be removed away from the main body, also the handle and wheels. The trolley is separated to several small pieces. The size of the trolley is so reduced that it can be put into a normal luggage for storing or transportation. When the trolley is in use, the main body tubes are pulled out and locked firmly by a quick fix and release mechanism. All parts will be assembled onto the main body. The trolley is ready for use.

A quick fix and release mechanism is arranged in the handle and the main body tubes 11,12,13 which allows the main body tubes 11,12,13 to slide into one another to reduce the length of the main body 11,12,13 for storing or transportation. When the main body tubes are extended for use, the quick fix and release mechanism holds the main body tubes 11,12,13 firmly extended for operation. Such a quick fix and release mechanism is widely used in many different branches.

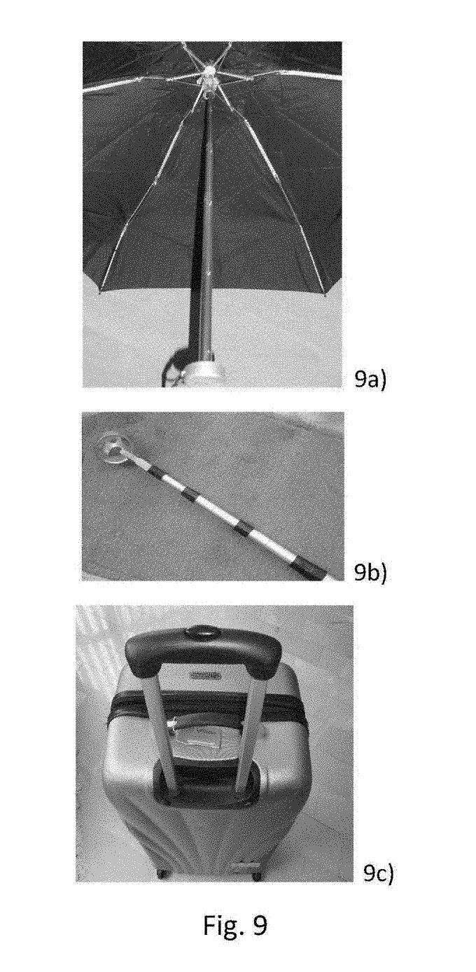

One of such mechanism is used in the retractable umbrella with two or more sections in the stem (please see FIG. 9a). The umbrella is very small in storing and is able to be put into a lady hand bag. When you want to use it, you open the umbrella and pull out the stem to the end. All sections are fixed by the protruding balls in each section.

Another quick fix and release mechanism is already used in the golf ball retriever, which comprises several section rods in one another. If you want to extend the length of the golf ball retriever, you turn the section rod to the left to release the lock and pull out the section and then turn the section rod to the right to fix the section. You can extend the length of the retriever so long till all section rods are extended. This is the so called telescope rods (FIG. 9b).

Further quick fix and release mechanism is used in almost every travelling luggage with wheels (shown in FIG. 9c). The handle of the luggage is kept in the integrated tube in the luggage. When you want to move or pull the luggage, you need only to press the button in the handle and pull out the handle simultaneously. Then you have a handle to move the luggage. If you want to retract it, you press the button again and push down the handle simultaneously into the tube. The handle disappears in sight and the luggage is ready for transportation. The handle can be made of several sections, which can slide into one another and having different length for suiting our body height for a convenient operation, especially for the small luggage or bag which is much lower than the big luggage.

All material of the golf trolley in this invention are preferably made of light materials, such as aluminum, aluminum alloy, titan, titan alloy, carbon fiber, plastic, plastic steel, . . . etc. or the combination of them, to reduce the weight for air travelling. The wheels can be also made of rubber with/without tube. Certainly, it is also convenient for the ground transportation in cars.

The invention will be better understood with following description together with drawings:

FIG. 1 shows the conventional golf trolleys which can be seen in any golf store. FIG. 2 shows the conventional golf trolleys which are folded or disassembled for storing or transportation.

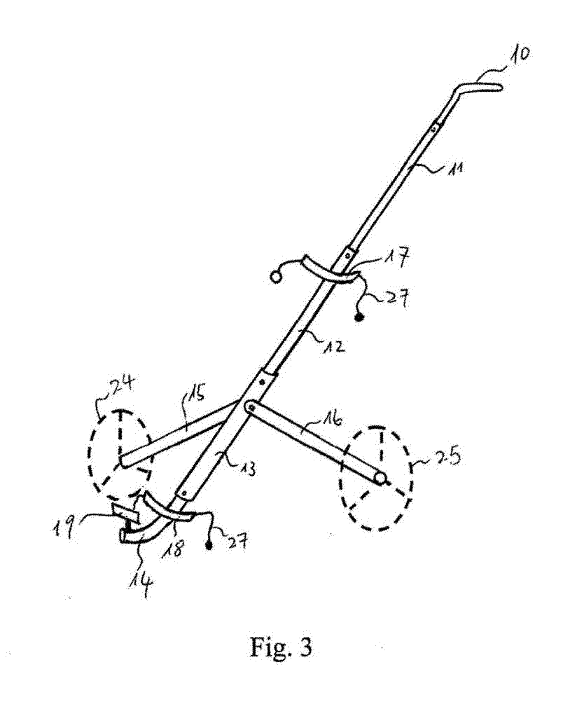

FIG. 3 shows the first embodiment of the invention. The main body 11,12, 13 of trolley comprises three tubes 11,12,13 which has different diameters and can slide into one another for storing. The wheel rods 15,16 are removable arranged on the both sides of the bottom tube 13 of the main body 11,12,13. It can be also pivotally arranged on the both sides of the bottom tube 13. The wheel axis 20 (not shown in the FIG. 3) can be fixed on or removable arranged in the lower end of the wheel rods 15,16 for mounting the wheels.

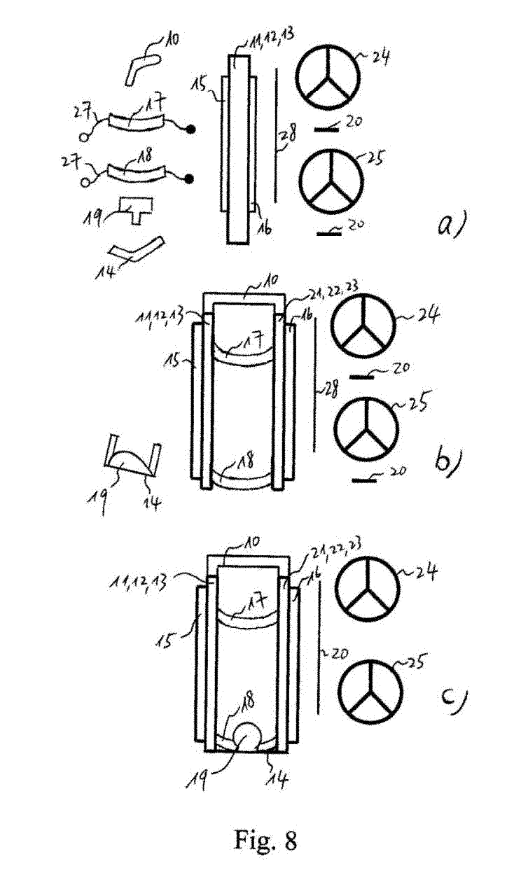

For storing or transportation, handle 10, wheels 24,25, bag holders 17,18 with bag fasten means 27, bag rest 19 and ground rest 14 will be detached from the main body 11,12,13. The wheel rods 15,16 will be either detached from or turn closely to the main body 11,12,13. The main body will be retracted to a length of only one tube 13 long (please see FIG. 8a).

The whole length of the main body 11,12,13 plus handle is generally around 140 cm. It is preferable having the main body separated by 3 or 4 main body tubes. The main body tubes have different diameters for sliding into one another. The largest tube is preferable having at least 2 cm of inside diameter and a thickness of at least 1 mm and the other tubes have reduced diameter accordingly and have at least 1 mm of thickness to form a stable trolley. The size of wheel is preferable having at least 20 cm in diameter and at least 3 cm in width for an easy operation. The ground rest 14 can be a wheel. It is then preferable to be smaller than the main wheels 24,25, for example 10 cm in diameter. In such a construction, it is possible to have the disassembled golf trolley having a package size of 40 cm×20 cm×8 cm or smaller. Thus, it can be put into any conventional luggage.

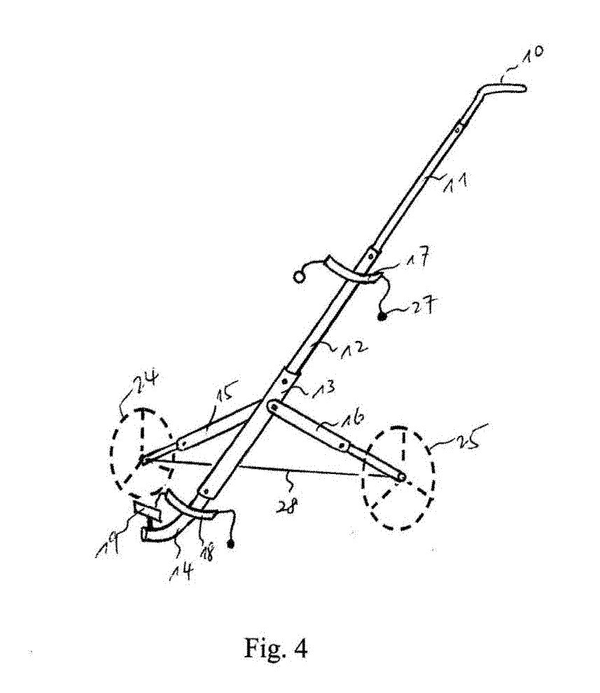

FIG. 4 shows a further embodiment of the invention which is mostly same like the embodiment in FIG. 3 but with wheel rods 15,16 comprising several tubes, which are able to slide into one another to reduce the length of wheel rod for storing. Besides, the wheel rod can be strengthened by a stabilization rod 28 removable arranged between two wheel rods 15,16.

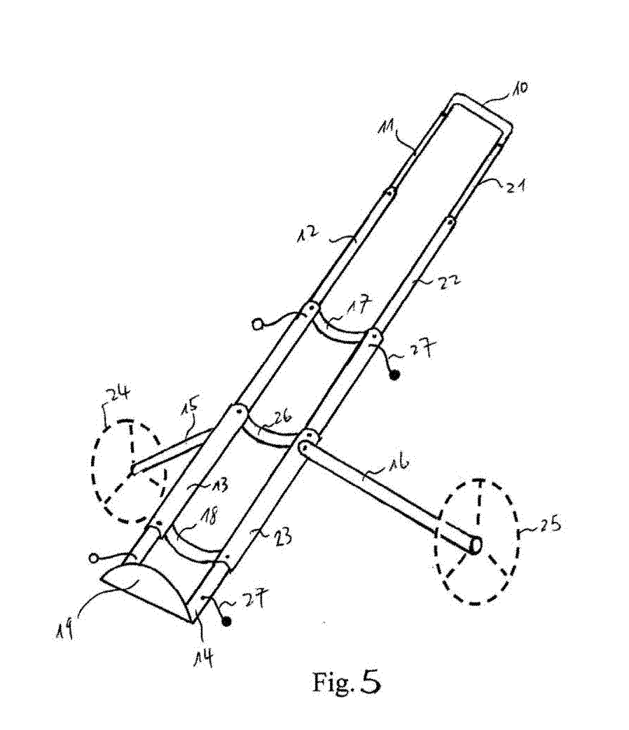

FIG. 5 shows another embodiment of the invention which has two rows of main body tubes 11,12,13,21,22,23. The handle connects two rows of main body tubes on the top. The two rows of main body tubes are further connected by connecting means 17,18,26. The connecting means 17,18, 26 can be made curved for receiving golf bag and equipped with bag fasting means 27 to be a golf bag holder. The ground rest 14 and bag rest 19 can be made of one piece. The bag rest 19 can also be made foldable against the ground rest 14 for saving space in the storing. The bag fasting means 27 can be also arranged on the tubes of ground rest 14 instead of on the lower bag holder 18. For storing or transportation, all parts will be retracted, detached or folded as shown in FIG. 8b and the trolley becomes a small package.

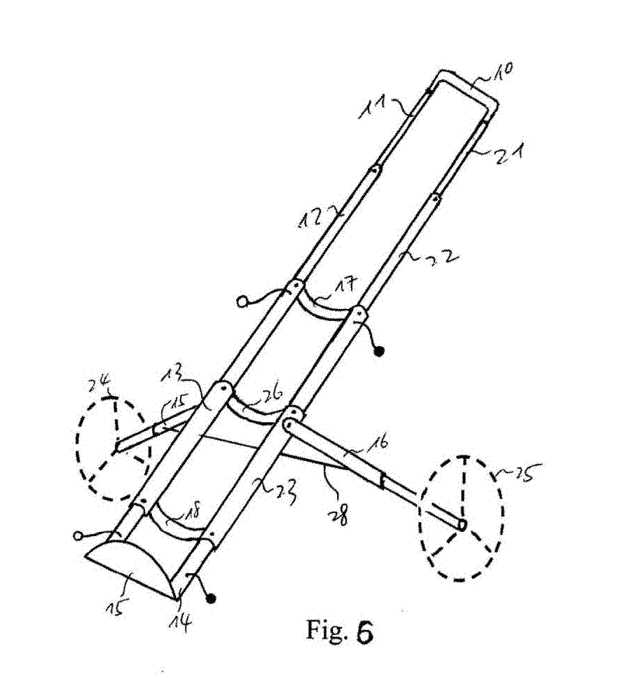

FIG. 6 shows further embodiment of the invention which is mostly same like the embodiment in FIG. 5 but with wheel rods 15,16 comprising several tubes, which can slide into one another. Besides, the wheel rod can be strengthened by a stabilization rod 28 removable arranged between two wheel rods 15,16.

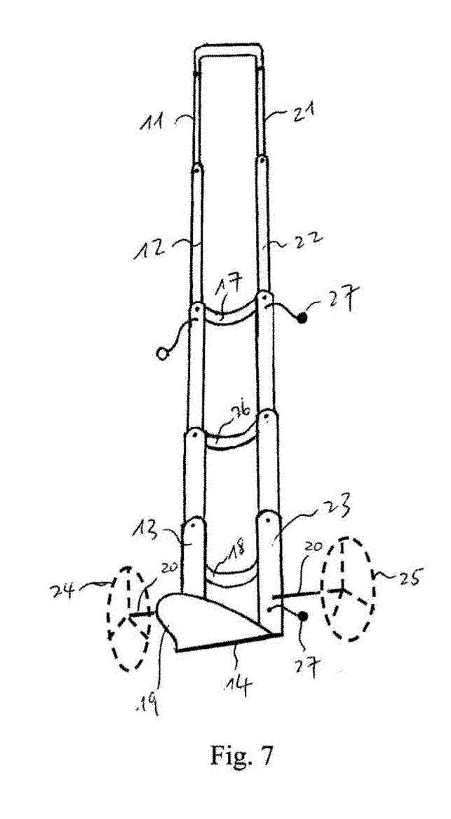

FIG. 7 shows further embodiment of the invention which use longer wheel axis 20 as wheel rods arranged on the bottom tube 13,23 of the main body for mounting wheels 24,25. The wheel axis 20 can be made of two pieces or one piece through the both bottom tubes 13,23. The bag rest 19 is arranged foldable against the ground rest 14. For storing or transportation, all parts will be retracted, disassembled and/or folded as shown in FIG. 8c.

1. A golf trolley, comprising a main body, a handle arranged on the top of the main body, a ground rest, a bag rest, two bag holders with bag fasten means, two wheel rods with wheel axis and two wheels, wherein
the main body comprising at least two tubes, which have different diameters for sliding one into another and
a quick fix and release mechanism arranged in the handle and the main body tubes which allows the main body tubes to slide one into another when the main body tubes are retracted and which holds the main body tubes firmly extended when the main body tubes are extended;
wherein the wheel rods are detachable or pivotally arranged on the both sides of the main body;
wherein the handle, the ground rest, the bag rest, the bag holders with the bag fasten means are detachable arranged on the main body and the two wheels are detachable arranged on the wheel axis.

2. The golf trolley of claim 1, wherein the main body comprises two rows of tubes which are connected by handle and at least one connecting means.

3. The golf trolley of claim 1, wherein the ground rest is a wheel or the ground rest and the bag rest are formed together in one piece.

4. The golf trolley of claim 1, wherein the wheel rod comprises plurality of tubes which are allowed to slide one into another.

5. The golf trolley of claim 1, wherein a stabilization means is detachable arranged between two wheel rods for stabilizing the wheel rods.

6. The golf trolley of claim 1, wherein the bag rest and/or the ground rest are foldable.

7. The golf trolley of claim 1, wherein handle, ground rest, bag rest, and bag holders with bag fasten means are detachable for storing and transportation.

8. The golf trolley of claim 1, wherein a size of the trolley for storing or transportation is no larger than 40 cm×20 cm×8 cm.

9. The golf trolley of claim 2, wherein the connecting means are curved for receiving the golf bag and equipped with bag fasten means forming a golf bag holder.

10. The golf trolley of claim 1, wherein the golf trolley is made of a light material, selected from the group consisting of aluminum, aluminum alloy, titan, titan alloy, carbon fiber, plastic, plastic steel, and a combination thereof; wherein the trolley is powered electrically and equipped with at least one accessory/selected from the group consisting of a battery, a brake, a score card holder, a score counter, and a ball/tee holder.
